(19) United States
(12) Patent Application Publication
(10) Pub. No.: US 2014/0204800 A1
(43) Pub. Date: Jul. 24, 2014

(54) BUFFER STATUS INDICATION IN WIRELESS COMMUNICATION

(71) Applicant: FUJITSU LIMITED, Kawasaki-shi (JP)

(72) Inventor: Timothy MOULSLEY, Caterham Surrey (GB)

(73) Assignee: FUJITSU LIMITED, Kawasaki-shi (JP)

(21) Appl. No.: 14/186,472

(22) Filed: Feb. 21, 2014

Related U.S. Application Data
(63) Continuation of application No. PCT/EP2011/069445, filed on Nov. 4, 2011.

(51) Int. Cl. H04W 8/22

(52) U.S. Cl. CPC H04W 8/22
USPC 370/254

(57) ABSTRACT

A wireless communication method in which a station is capable of performing transmission via a plurality of antenna ports simultaneously on an uplink to a wireless communication network, a plurality of transmission possibilities for said transmission being defined by the available antenna ports and/or formats available for transmitting from an antenna port, the station signifying information to the network by selecting from the transmission possibilities.

### CROSS-REFERENCE TO RELATED APPLICATIONS

This is a continuation of International Application No. PCT/EP2011/069445, filed on Nov. 4, 2011, now pending, the contents of which are herein wholly incorporated by reference.

### FIELD OF THE INVENTION

The present invention relates to a transmission method in a wireless communication system comprising a base station and another station such as a user terminal for transmitting transmission data to the base station. The present invention further relates to a user terminal, to a base station and a computer program for use in the method.

Particularly, but not exclusively, the present invention relates to uplink communication procedures in accordance with the LTE (Long Term Evolution) and LTE-Advanced radio technology standards as, for example, described in the 36-series (in particular, specification documents 3GPP TS 36.xxx and documents related thereto), Release 10 and subsequent of the 3GPP specification series.

### BACKGROUND OF THE INVENTION

A wireless communication system typically comprises several geographical areas which are called “cells”. The term “cell” generally refers to a radio network object as a combination of downlink and optionally uplink resources. A user terminal, henceforth generally referred to as a “user equipment” or UE, can uniquely identify a cell from a (cell) identification that is broadcast over the geographical area from an Access Point or base station, henceforth also referred to as an eNB. A wireless communication system, and the cells within it, may be in FDD (Frequency Division Duplex) or TDD (Time Division Duplex) mode. A base station may communicate with the UEs assigned to the serving cell(s) using the frequency domain and time domain as communication resources. Further, communication resources may be allocated to the UEs of a cell in the spatial domain or code domain. Examples of wireless communication systems are UMTS (Universal Mobile Telecommunications System), LTE, LTE-Advanced, WiMAX, also referred as “4G”, and the like. The present invention is particularly, but not exclusively, concerned with LTE-Advanced systems and specifically those compliant with Release 10 and subsequent iterations of the LTE-Advanced specifications.

FIG. 1 shows a wireless communication system 1 comprising a terminal 10, a base station 20 and a controller 30 in accordance with an embodiment of the present invention. The UE 10 is adapted to communicate with the base station 20 and, in particular, to transmit transmission data on the uplink to the base station 10. The UE 10 may be pre-configured for any of the embodiments to be described by higher layer signalling, for example, RRC (Radio Resource Control) signalling. The UE 10 may be controlled to carry out the method according to an aspect of the invention by a controller 30 comprised in the UE 10 itself, in the base station 20 or in a network entity (not shown). In LTE, uplink transmission is organized in “frames” each containing twenty slots, two consecutive slots being referred to as a “subframe”.

In such a wireless communication system, data channels are shared channels; that is, for each transmission time interval, a new scheduling decision is taken regarding which UEs are assigned/allocated to which time/frequency/spatial/code etc resources during this transmission time interval. Several “channels” for data and signalling are defined at various levels of abstraction within the network. FIG. 2 shows some of the channels defined in LTE-based systems at each of a logical level, transport layer level and physical layer level, and the mappings between them. For present purposes, the uplink channels are of particular interest.

In FIG. 2, physical channels defined in the uplink are a Physical Random Access Channel (PRACH), a Physical Uplink Shared Channel (PUSCH), and a Physical Uplink Control Channel (PUCCH). An uplink physical channel corresponds to a set of resource elements carrying information originating from higher layers. In addition to the uplink channels, uplink signals such as reference signals, primary and secondary synchronization signals are typically defined. An uplink physical signal is used by the physical layer but does not carry information originating from higher layers. Modulation schemes supported on the uplink are, for example BPSK, QPSK, 16QAM and 64QAM.

Incidentally, although FIG. 2 shows some logical channels, it should be noted that these are not related to the Logical Channel Groups (LCGs) discussed later. The logical channels (for different purpose within the LTE system) and logical channel groups (possibly containing data for different applications) are separate concepts

Hereby also incorporated by reference is 3GPP TS 36.300 providing an overall description of the radio interface protocol architecture used in LTE-based systems and in particular section 5.2 of 3GPP TS 36.300 relating to uplink transmission schemes. The physical channels in the uplink of LTE-based systems are described, for example, in 3GPP TS 36.211, section 5, which is hereby incorporated by reference.

User data and optionally also higher-level control signalling is carried on the Physical Uplink Shared Channel PUSCH. The physical uplink control channel PUCCH carries uplink control information such as a scheduling request (SR), explained in more detail shortly, and a channel quality indicator (CQI) report. As illustrated in FIG. 2, there is a downlink counterpart channel to the PUCCH, which is the Physical Downlink Control Channel (PDCCH) for carrying, in response to the scheduling request, an uplink scheduling grant. Such a message also indicates the transmission rate (i.e. modulation and code rate). If PUSCH transmission occurs when the PUCCH would otherwise be transmitted, the control information to be carried on PUCCH may be transmitted on PUSCH along with user data. Simultaneous transmission of PUCCH and PUSCH from the same UE may be supported if enabled by higher layers. The PUCCH may support multiple formats as indicated in 3GPP TS 36.211, section 5.4.

Because transmissions between UE and base station are prone to transmission errors due to interference, a procedure is available for each packet sent in uplink and downlink direction to be acknowledged by the receiver. This is done by sending Hybrid Automatic Repeat Request (HARQ) acknowledgments or non-acknowledgments (ACK/NACK) on control channels. On the downlink, ACK/NACK is sent on a Physical HARQ Indicator Channel (PHICH). On the uplink ACK/NACK is sent on PUCCH.

The Physical Random Access Channel PRACH is used to carry the Random Access Channel (RACH) for accessing the network if the UE does not have any allocated uplink transmission resource. If a scheduling request (SR) is triggered at the UE, for example by arrival of data for transmission on PUSCH, when no PUSCH resources have been allocated to the UE, the SR is transmitted on a dedicated resource for this purpose. If no such resources have been allocated to the UE, the RACH procedure is initiated. The transmission of SR is effectively a request for uplink radio resource on the PUSCH for data transmission.

Accordingly, the UE then expects an uplink grant in order to transmit on PUSCH radio resource of which it may receive details either in a Random Access Response or dynamically on the PDCCH in response to the scheduling request SR. As described in 3GPP TS 36.321 relating to the Medium Access Control (MAC) protocol specification and hereby incorporated by reference, the SR is transmitted on the PUCCH for requesting the allocation of PUSCH resources for new data transmission. Pending allocation of suitable resources, the UE holds the data temporarily in a buffer. In fact, it stores data for each of a number of logical channel groups, as will be explained.

In order to schedule uplink transmissions efficiently the network needs to be aware of the amount of data that the UE needs to transmit, the priority of such data and the uplink channel conditions. There is already provision in LTE specifications for this, by the UE sending BSRs (buffer status reports) along with data transmissions via PUSCH and transmission of UL sounding reference signals (SRS). However, if the UE has no PUSCH resources available, there is no means to send BSR. In such cases a scheduling request is triggered in the UE.

The process is shown in FIG. 3. Assuming that the UE 10 already has some allocated uplink transmission resource, it sends a Scheduling Request SR to the base station (eNB 20) as shown by the topmost arrow in the Figure, using pre-allocated resources on PUCCH. The SR indicates that the UE needs to be granted UL resources on PUSCH. In some cases the UE may not have an SR resource allocation on PUCCH, and then the RACH procedure would be initiated as already mentioned.

Following the identification by the UE of the need for PUSCH resources, and triggering SR transmission, on receiving the SR the network will typically send a PDCCH message with a small resource allocation on PUSCH. This is indicated by the second arrow, labelled “Scheduling Grant” in FIG. 3. A large allocation could be granted, but at this point the network does not have an accurate view of the UE buffer state or the UL channel conditions, so a large resource grant could well be wasted. The same PDCCH grant message may be used to trigger aperiodic SRS in order obtain the uplink channel state.

Receipt of the Scheduling Grant enables the UE to send the transmission marked “Transmission Data/BSR” in FIG. 3. As indicated, this PUSCH transmission will typically include a buffer status report BSR, and after successful reception, the network will have knowledge of both UE buffer status and UL channel state. This allows efficient scheduling of PUSCH resources to match the UE traffic requirements.

Thus, the eNB responds to the UE by sending, in addition to an ACK as indicated in the Figure, a Scheduling Grant suitable for the UE's traffic requirements. Finally, as shown by the arrow labelled “Transmission Data”, the UE sends the data contained in its buffer. It will be noted that the process shown in FIG. 3 is relatively complex, leading to delay before the UE is able to send the data held in the buffer.

The SR and BSR protocols are further described in 3GPP TS 36.321, sections 5.4.4, 5.4.5, and 6.1.3, and the SR procedure for a terminal procedure for determining physical uplink control channel assignment is described in 3GPP TS 36.213, section 10, which is hereby incorporated by reference.

The network provides the UE with resources for the transmission of SR using the following parameters:
sr-PUCCH-ResourceIndex. This identifies the particular PUCCH resource, where up to 36 combinations of 12 cyclic shifts and 3 spreading codes per PUCCH RB (Resource Block) are available. This applies for antenna port 0.
sr-ConfigIndex. This identifies the periodicity and offset available for SR in terms of subframes.
dsr-TransMax. This indicates the number of times a give SR transmission may be repeated (4, 8, 16, 32 or 64 times).
sr-PUCCH-ResourceIndexP1-r10. In the case of more than one antenna port in the UL, this identifies the PUCCH resource to be used for antenna port 1.

Various formats are available to the UE for sending a SR and/or ACK/NACK signal on PUCCH. The formats relevant for present purposes are called Format 1, Format 1a and Format 1b and their properties are shown in FIG. 4.

The following applies when there is no ACK/NACK transmission in the same subframe (using PUCCH Format 1):
When a scheduling request is triggered, the UE transmits SR (BPSK symbol value “1”) on the PUCCH resource configured for SR with port 0. (The modulation scheme for Format 1 is shown as “N/A” in FIG. 4, since in principle a PSK symbol with any phase could be transmitted to indicate SR on its own; however the LTE specification requires that the signal is equal to BPSK with phase corresponding to the value “1”). The same signal is transmitted on the resource configured for SR with port 1.
When a scheduling request is not triggered, the UE transmits nothing on either of the PUCCH resources configured for SR with port 0 or port1.

For transmission of the hybrid-ARQ acknowledgement, the HARQ ACK bit(s) are used to generate a BPSK/QPSK symbol—depending on the number of codewords present. The modulated symbol is then used to generate the signal to be transmitted in each of the two PUCCH slots.

The following applies when there is an ACK/NACK transmission in the same subframe (using PUCCH Format 1a/1b):
When a scheduling request is triggered, the UE transmits the ACK/NACK on the PUCCH resource configured for SR with port 0. The same signal is also transmitted on the resource configured for SR with port 1.
When a scheduling request is not triggered, the UE transmits ACK/NACK on the PUCCH resource configured for ACK/NACK with port 0.

PUCCH Format 1a is used for the case of 1 ACK/NACK bit (e.g. acknowledgement for a single codeword), while Format 1b is used for the case of 2 ACK/NACK bits (e.g. for two codewords).

FIG. 5 shows functional units of a UE for transmitting its data to the base station (eNB). A scrambling section 11 scrambles the data bits in a way which is specific to that UE, allowing recognition at the base station. A modulation mapper 12 applies a selected modulation scheme to the scrambled bits to generate modulated symbols. Whilst certain modulation schemes may be laid down for control signalling as already mentioned, in general the UE uses the modulation scheme best suited to the current channel conditions for maximising the transmission rate. The modulated symbols are fed to a transform precoder 13 which performs a discrete Fourier transform for converting between the time and frequency domains. The converted signal is then sent to a resource element mapper 14 to be divided into sets each corresponding to a SC-FDMA symbol, and mapped onto resource elements, which are the frequency and time slots available for transmission. Finally a SC-FDMA signal generator 15 performs an inverse discrete Fourier transform back to the time domain, to generate SC-FDMA signals for transmission, SC-FDMA being the transmission scheme adopted for the uplink in LTE.

The problem addressed by this invention is that in a system such as LTE, any delay in the UE being granted sufficient UL transmission resources increases the latency and reduces the throughput. In order to allocate the correct amount of resources the network needs to be aware of how much data is present in the UE buffer ready for UL transmission. Information on priority will also be useful. In particular, in the case that a UE sends SR, followed by a PUSCH allocation sufficient to carry BSR, there may be a significant delay before a further allocation of PUSCH is sent with resources matching UE requirements. This delay will be increased by any failure of SR detection by the network, failure of PDCCH reception at the UE (delaying initial PUSCH allocation) or HARQ retransmission delays in reception of the PUSCH carrying BSR.

Therefore techniques for providing the LTE network with information on UE buffer status more quickly or reliably after a scheduling request has been triggered are of significant interest.

### SUMMARY OF THE INVENTION

According to a first aspect of the present invention, there is provided a wireless communication method in which a station is capable of performing transmission via a plurality of antenna ports simultaneously on an uplink to a wireless communication network, a plurality of transmission possibilities for said transmission being defined by the available antenna ports and/or formats available for transmitting from an antenna port, the station signifying information to the network by selecting from the transmission possibilities.

Preferably the station selects from the plurality of transmission possibilities by selecting one or more of the antenna ports to be used for the transmission and/or by selecting, among a set of predefined formats, a format to be used for transmitting from the or each selected antenna port respectively.

Preferably the transmission is a request for resources, the transmission having a content for requesting the resources whilst signifying the information by the transmission possibility selected.

In an embodiment of the present invention, a selected transmission possibility uses a plurality of the available antenna ports to which distinct uplink resources are assigned.

Alternatively, or in addition, a selected transmission possibility uses a format having a predetermined modulation scheme for signals transmitted from a said antenna port.

In preferred embodiments of the present invention the network is based on LTE Release 10 or later and the transmission comprises a scheduling request. The predetermined modulation scheme for signals transmitted from a said antenna port may be one defined in LTE for a scheduling request (such as Format 1/1a/1b), or may be distinct from any defined in LTE for a scheduling request (such as Format 1c to be described). Both kinds may be employed together.

The transmission may comprise an ACK/NACK signal transmitted from one antenna port.

Preferably, the information comprises information on buffer status. The information on buffer status comprises information on at least one logical channel group among a plurality of logical channel groups, or may relate to a combination of logical channel groups.

More particularly the information on buffer status may comprise any of:
an indication of an amount of data in a logical channel group having a highest priority among the plurality of logical channel groups;
an indication of a total amount of data in the plurality of logical channel groups;
an identification of a logical channel group having the greatest amount of data among the logical channel groups;
an identification of the logical channel group with the highest priority which has any data available for transmission; and
an identification of the logical channel group with the highest priority which has data of an amount exceeding a threshold available for transmission.

According to a further aspect of the invention there is provided a wireless communication method in which a station is capable of performing transmission via a plurality of distinct resources on an uplink to a wireless communication network, a plurality of transmission possibilities for said transmission being defined by locations of said resources and/or formats available for transmitting using said resources, the station signifying information to the network by selecting from the transmission possibilities. Such transmission may be simultaneous from one antenna port (if allowed in future iterations of the LTE standards) or from different antenna ports. The information signified is preferably information on buffer status at the station.

Accordingly, embodiments of the invention are based on the gist that a message is sent from the terminal to the base station and that sending the message provides further information to the base station. By providing the base station with further information, an exchange of control signalling can be reduced or omitted, thus rendering the transmission method for transmitting data from the terminal to the base station more efficient.

The user terminal may be pre-configured (which may be understood as also including “pre-allocated” and “pre-scheduled”) with appropriate resources and parameters for enabling the terminal to quickly and reliably transmit the message as well as provide the further information. Preferably, the network or base station allocates scheduling request resources and/or parameters for a scheduling request to the terminal for enabling it to transmit the scheduling request as soon as it is triggered at the terminal.

According to a second aspect of the present invention, there is provided a wireless communication system operated in accordance with any method as defined above.

A third aspect provides a subscriber station which is a station for use in the above methods and configured to perform selection among said transmission possibilities for signifying said information to the network.

A fourth aspect relates to base station equipment for use in the above methods and configured to extract said information from said transmission by recognising which one or more of the antenna ports has been used for the transmission by the station and/or by recognising, among a set of predefined formats, which format has been used for transmitting from the or each selected antenna port respectively.

In another aspect, the present invention relates to a computer program (which may be stored to a computer-readable medium) comprising program code for causing a computer to carry out a method as described in the present application or to operate as a user terminal as described in the present application or a base station as described in the present application.

### BRIEF DESCRIPTION OF THE DRAWINGS

Preferred embodiments of the present application are described, by way of example, with reference to the accompanying drawings in which:—

FIG. 1 illustrates a wireless communication system in accordance with an embodiment of the present invention;

FIG. 2 illustrates logical, transport and physical channels employed in an LTE-based system and the corresponding mapping thereof;

FIG. 3 illustrates an example of a conventional radio resource allocation signalling procedure of an LTE-based system;

FIG. 4 shows Formats 1, 1a and 1b used to send a scheduling request SR or an ACK/NACK in an LTE-based system;

FIG. 5 is a block diagram of functional units in a UE for transmitting an uplink signal to a base station;

FIG. 6 illustrates an example of a radio resource allocation signalling procedure of an LTE-based system in accordance with the present invention; and

FIG. 7 illustrates data amounts in each of a plurality of logical channel groups having different respective priorities.

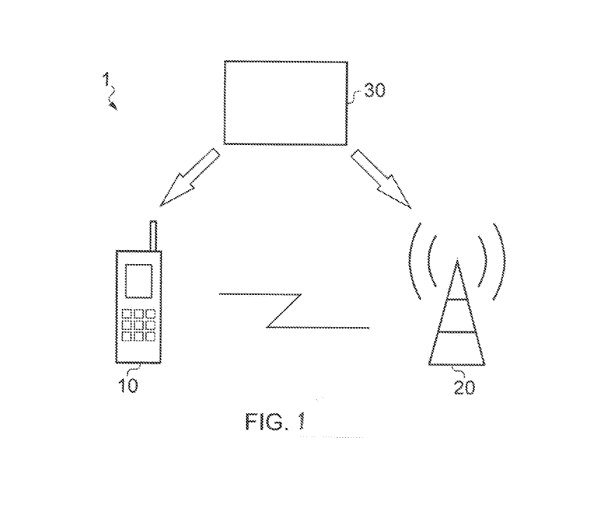

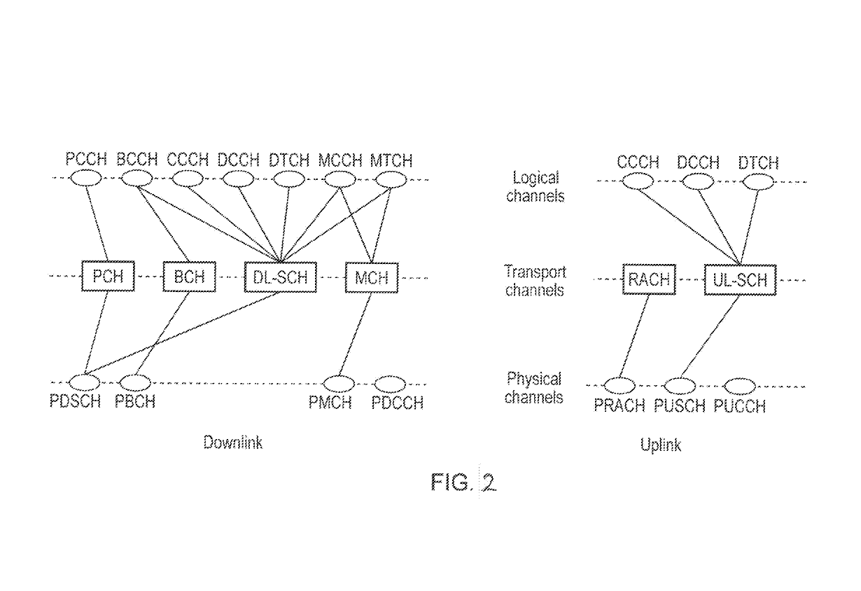

### DETAILED DESCRIPTION

The embodiments described below are described in the context of LTE, where the wireless communication system (also referred to as the “network”) operates using FDD and comprises one or more base stations (also referred to as “eNBs”), each controlling one or more downlink cells, each downlink (DL) cell having a corresponding uplink cell. Each DL cell may serve one or more terminals (also referred to as “UEs”) which may receive and decode signals transmitted in that serving cell.

In an LTE system, the eNB sends control channel messages on PDCCH to the UEs in order to control the use of transmission resources in time, frequency, code and spatial domains for transmission to and from the UEs. A radio resource in the time domain is defined with respect to the timing of the transmission of the signal on the radio resource. A PDCCH message indicates whether the data transmission will be in the uplink using PUSCH or downlink using PDSCH. It also indicates the transmission resources, and other information such as transmission mode, number of antenna ports, data rate, number of codewords enabled. In addition the PDCCH message indicates which reference signals may be used to derive phase reference(s) for demodulation of a DL transmission. Reference signals for different antenna ports, but occupying the same radio resource locations, are distinguished by different spreading codes. The eNB obtains information on the downlink (DL) channel by means of CSI reports transmitted by the UE, and obtains information on the uplink (UL) channel by making channel measurements using sounding reference signals (SRS) transmitted by the UE.

In order to allocate appropriate resources by scheduling UL transmissions from UEs with appropriate transmission parameters and resources, when no PUSCH resources are available a scheduling request SR is triggered in the UE of the LTE system as already mentioned. PUCCH resources for SR are defined in terms of resource index which indicates the resource within a subframe and a configuration index which indicates the periodicity of occurrence of subframes in which the resource is available, together with an offset which indicates the position of the subframe within the period. The number of times a given SR may be transmitted is also configured. This allows the UE to repeat the SR if it is not granted UL resources. For UEs with more than one antenna port in the UL, different PUCCH resources can be configured (during a prior set-up procedure performed via RRC signalling) for each of two antenna ports (0 and 1), but the same configuration index would apply to both ports.

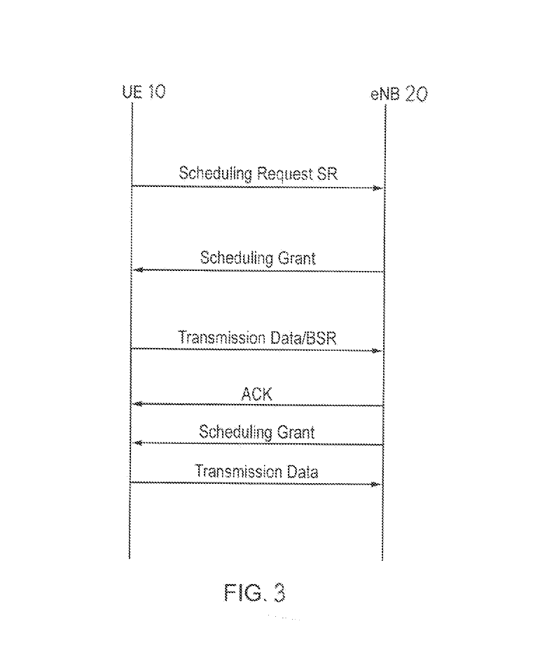

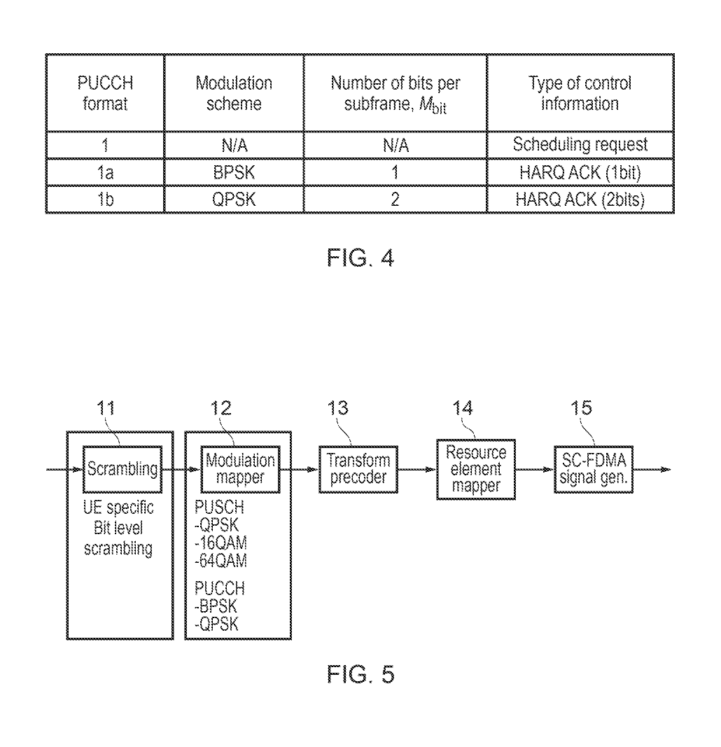

As already described with respect to FIG. 3, the SR causes the base station to issue a scheduling grant sufficient for the UE to send a buffer status report BSR. This is used to indicate to the base station the amount of data waiting for transmission on the uplink, which is typically measured in terms of logical channel groups (LCGs). The assignment of data to a LCG could be on the basis of required quality of service (e.g. priority, delay requirements). In LTE the LCGs are processed with different priorities. Thus, the concept of LCGs allows the BSR to provide information on data amounts categorised by priority. Currently, four LCGs are defined but it is not necessary that all the defined logical channel groups are used. LCGs may be identified by a numerical index.

A principle underlying embodiments of the present invention is that, in LTE UEs with more than one UL transmit antenna, transmission of SR by the UE is modified to carry information about buffer status. This is done by making use the flexibility to transmit different SR signals from different antenna ports in different PUCCH resources.

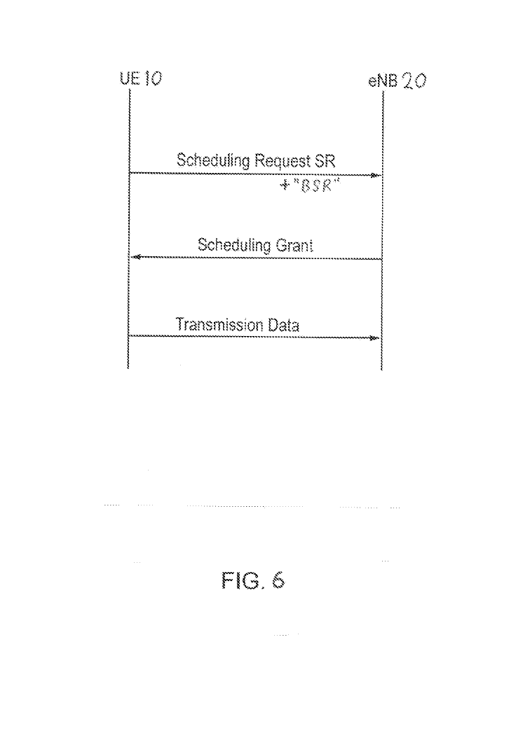

FIG. 6, which should be compared with FIG. 3, indicates this principle. As before, the UE 10 sends a SR to the eNB 20. However, now the SR itself carries with it some additional information regarding buffer status, in a manner to be explained shortly. This is indicated by the arrow labelled Scheduling Request SR+“BSR”, the “BSR” denoting that additional information is provided which is tantamount to a BSR, even though not provided explicitly in the conventional manner.

Then, knowing at least some information about the buffer status, the eNB does not need to grant resource only for a subsequent BSR. It may proceed directly to grant a resource allocation which takes account of the data in the UE's buffer, as shown by the arrow labelled Scheduling Grant. The UE may then immediately send its transmission data without having to wait for a separate scheduling grant after BSR.

The way in which the above-mentioned additional information is conveyed by the transmission of the SR will now be explained.

In LTE Release 10, SR transmission may be configured using different resources for different antenna ports, but this configuration flexibility is not exploited. Therefore, the following options are available for transmission on different ports when there is no ACK/NACK transmission in the same subframe:
No SR on port 0 or port 1 (i.e. SR not triggered)
SR on port 0, no SR on port 1
No SR on port 0, SR on port 1
SR on both port 0 and port 1

Each SR transmission can use different formats:
Fixed BPSK value (according to current Format 1)
1 bit (BPSK) (similar to Format 1a)
2 bits (QPSK) (similar to Format 1b)

Using QPSK will allow an indication of up to 24 different values or states (more than 4 bits)

If an ACK/NACK is to be transmitted in one of the resources, this precludes (in the current state of LTE) using the same resources to send additional information in accordance with the present invention. This is because one current constraint in LTE is to only transmit one uplink signal at time (on each port). However, in the other resource there would still be the possibility of no transmission or sending up to 2 bits of information. The network knows when one of the ports is being used for ACK/NACK and another for sending additional information, because the resources used will be different.

That is, in general the network knows when to expect ACK/NACK, so this can be used to identify whether the network should expect Format 1a/1b, or a similar signal conveying different information, but there could be some error cases (e.g. if the UE is not aware that it is supposed to send ACK/NACK). However, the resources for ACK/NACK and SR are different, so if a positive SR transmission is supposed to take place in the same subframe as ACK/NACK, format 1a/1b transmitted as the resource defined for SR. Otherwise Format 1a/1b is transmitted in the ACK/NACK resource which indicates “negative SR” (i.e. same as no SR transmitted).

Each of the different transmission possibilities can be used to indicate information about buffer status at the UE. For example, this can indicate a quantised version of the existing information that would otherwise be sent using BSR. In general, the transmission details of SR would be determined according to the status of the buffers at the UE for different logical channel groups, and possibly also previous status.

The invention could be included in LTE specifications. This invention can be used on its own or combined with other schemes for transmission of additional information or signals when SR is triggered.

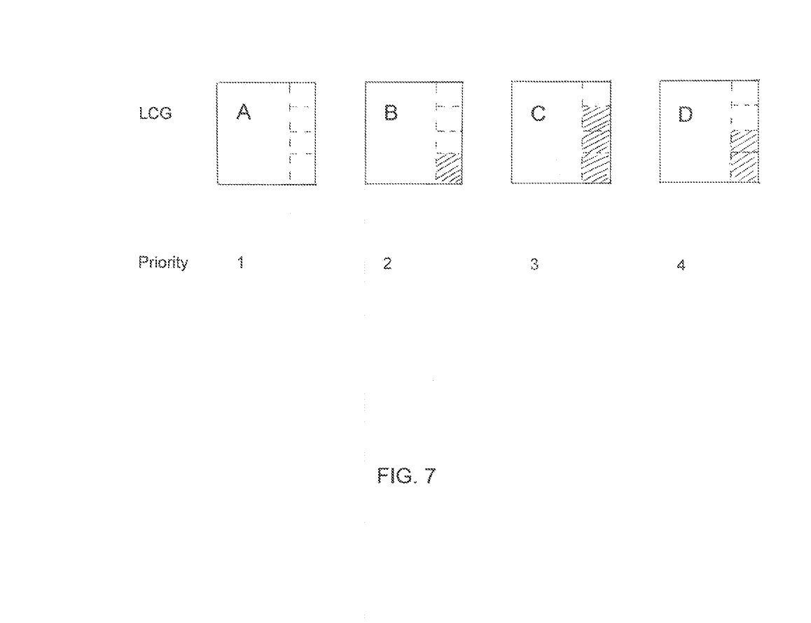

Having explained the principle underlying embodiments of the present invention, some particular embodiments will now be described with respect to FIG. 7.

### First Embodiment

### Transmission of Positive SR on One or More Ports

In a first embodiment, the UE is configured with dedicated PUCCH resources that it uses when a scheduling request is triggered. Different resources are configured for port 0 and port 1. When a scheduling request is triggered, the UE transmits SR on the first available PUCCH resources available for SR. A positive SR is indicated by a defined BPSK value, using PUCCH Format 1 (as defined in LTE Release 8). When there is an ACK/NACK to be transmitted in the same subframe (and on the same port as an SR transmission), PUCCH Format 1a/1b is used. Format 1a is used to transmit one of two possible values using BPSK, and Format 1b is used to transmit up to four possible values using QPSK.

Since two ports are available, this means that three transmission possibilities exist (without ACK/NACK):
SR on port 0 (Format 1), no SR on port 1
No SR on port 0, SR on port 1 (Format 1)
SR on both port 0 (Format 1) and port 1 (Format 1)

The transmission possibilities can be expressed as follows.

Transmission possibilities in the first embodiment, no ACK/NACK:

| | Port 0 | Port 1 | No. of States |
|---|---|---|---|
| (a) | 1 state (F1) × | 1 state (no SR) = | 1 |
| (b) | 1 state (no SR) × | 1 state (F1) = | 1 |
| (c) | 1 state (F1) × | 1 state (F1) = | 1 |

Total number of states = 3

Thus, in this case any one of three distinct states or values can be signified to the network, assuming that “no SR on both ports” is not defined as a transmission possibility for sending SR, and would be equivalent to not sending SR. In this embodiment the number of states (or distinct indications possible regarding buffer status) is equal to the number of transmission possibilities (combinations of antenna ports). This is not necessarily the case in later embodiments, as one transmission possibility may allow multiple values to be signified, creating a larger number of states.

With ACK/NACK the possibilities are:
SR+ACK/NACK on port 0 (Format 1a/1b), no SR on port 1
No SR on port 0, SR+ACK/NACK on port 1 (Format 1a/1b),
SR on both port 0 and port 1 with the following sub-possibilities:
   1. SR+ACK/NACK on both port 0 (Format 1a/1b), and port 1 (Format 1a/1b),
2. SR+ACK/NACK on port 0 (Format 1a/1b), SR on port 1 (Format 1)
3. SR on port 0 (Format 1), SR+ACK/NACK on port 1 (Format 1a/1b)

However, eNB may not be able to reliably distinguish the different sub-possibilities (1, 2 or 3) for SR on both ports with ACK/NACK, so the preferred embodiment would adopt only one of these sub-possibilities (e.g. ACK/NACK on both port 0 and port 1).

Transmission possibilities in the first embodiment, with ACK/NACK:

| | | | No. of |
|---|---|---|---|
| | Port 0 | Port 1 | States |
| (a) | 1 state (F1a/b used for ACK/NACK) × | 1 (no SR) = | 1 |
| (b) | 1 (no SR) × | 1 state (F1a/1b) = | 1 |

and assuming sub-possibility 2. only:

| | | | |
|---|---|---|---|
| (c) | 1 (F1a used for ACK/NACK) × | 1 state (F1) = | 1 |

Total number of states = 3

FIG. 7 illustrates four LCGs shown schematically by the squares labelled A, B, C, and D, each having an associated amount of data awaiting transmission as indicated by the shading within each square. For simplicity, it is assumed that each LCG has up to four units of data, and each LCG has a respective different priority 1 to 4, with 1 being the highest.

In one version of this embodiment, the use of each transmission possibility indicates a different amount of data in the UE buffer for the Logical Channel Group (LCG) with the highest priority, and which has data available for transmission. In the example of FIG. 7, the selected transmission possibility would indicate the value zero, since there is no data waiting in LCG “A” having the highest priority of 1.

In a variation of this embodiment each transmission possibility indicates the total amount of data over all the UE buffers for all the LCGs. Referring to the example of FIG. 7, this would result in the transmission possibility indicating (as far as possible) the value six, as this is the total number of units of data waiting in all the LCGs. Of course, with only 3 states available in this embodiment it might not be possible to specify the total value exactly, but the total value may alternatively be indicated as a range, or by indicating that a predetermined threshold is exceeded.

In a further variation of this embodiment each transmission possibility indicates the LCG with the largest amount of data available for transmission. Referring to FIG. 7 again, this would be the LCG “C”, as this has the greatest amount of data of any of the LCGs, namely three units. Since there three transmission possibilities, but four LCGs, one LCG could be omitted from consideration (for example the one having the lowest priority), or one transmission possibility could correspond to two LCGs. In the latter case, this would tell the network that one of the two LCGs has the largest amount of data. It may not always be necessary for the network to know which one.

A similar approach can be applied in other variations of this embodiment.

In a further variation of this embodiment each transmission possibility indicates the LCG with the highest priority which has data available for transmission. In the example of FIG. 7 this would be LCG “B”.

In a further variation of this embodiment, each transmission possibility indicates the LCG with the highest priority which has an amount data available for transmission exceeding a threshold. The threshold for each LCG may be different and may be configured by higher layer signalling or fixed by the specification. If we suppose that the threshold is one, this would result in using the transmission possibility to indicate LCG “C”, as this is the highest-priority LCG with more than one unit of data available.

### Second Embodiment

### Transmission of Positive SR on One Port and Multi-Bit Indication on Another

The second embodiment is like the first embodiment except that a modified SR transmission based on a new format similar to Format 1b (or possibly 1a) is used on one port, and SR (Format 1) or SR+ACK/NACK (Format 1a/1b) is used on the other.

Denoting the new format as Format 1c, this can take the form of a QPSK symbol, which can convey two bits of information (in other words, four states). It can normally be assumed that QPSK would always be available in a cell, although at some low value of SNR transmission would become unreliable.
Format 1c can be viewed as Format 1b with SR plus additional information signifying BSR, and no ACK/NACK. As mentioned above the modulation can be the same but the information is different. The network can distinguish between Formats 1b and 1c on the basis of the context and/or resources used.

The transmission possibilities (without ACK/NACK) are now:
SR on port 0 (Format 1), SR on port 1 (Format 1c)
SR on port 0 (Format 1c), SR on port 1 (Format 1)

However, eNB may not be able to reliably distinguish these two possibilities so the preferred embodiment would adopt only one of them (e.g. SR on port 0 (Format 1), SR on port 1 (Format 1c)). With ACK/NACK transmission in the same subframe this would become, for example:
SR+ACK/NACK on port 0 (Format 1a/1b), SR on port 1 (Format 1c).

In other words port 0 is used for SR with or without ACK/NACK, with port 1 carrying the additional information for BSR purposes (or vice-versa).

In one version of this embodiment the use of each different QPSK symbol value in Format 1c indicates a different amount of data in the UE buffer for the Logical Channel Group (LCG) with the highest priority and which has data available for transmission. Thus, in the example of FIG. 7, the selected QPSK value would correspond to the amount 1, this being the number of units of data in LCG “B”.

In a variation of this embodiment each different QPSK symbol value in Format 1c indicates a different total amount of data over all the UE buffers for all the LCGs. Referring to FIG. 7 again, this would mean setting a value corresponding (as far as possible) to the amount 6, this being the total number of units of data in all the LCGs.

In a further variation of this embodiment each different QPSK symbol value in Format 1c indicates the LCG with the largest amount of data available for transmission. As before this would be LCG “C” in the example shown, thus the QPSK symbol value would be one preconfigured to represent this LCG.

In a further variation of this embodiment each different QPSK symbol value in Format 1c indicates the LCG with the highest priority which has data available for transmission, in other words LCG “B” in this example.

In a further variation of this embodiment each different QPSK symbol value in Format 1c indicates the LCG with the highest priority which has an amount data available for transmission exceeding a threshold. The threshold for each LCG may be different and may be configured by higher layer signalling or fixed by the specification. Assuming a threshold of one unit, this would be LCG “C”.

The above variations may be combined. For example, one bit in Format 1c can be used to indicate one of two LCGs (or pairs of LCGs), and another bit can be used to indicate the amount of data buffered for the indicated LCG (or LCGs).

### Third Embodiment

### A Combination of the First and Second Embodiments

The third embodiment is like the second embodiment except that additional possibilities include transmission of “No SR”. This leads to possible (distinguishable) combinations such as the following:
SR on port 0 (Format 1), SR on port 1 (Format 1c)
SR on port 0 (Format 1c), No SR on port 1
No SR on port 0, SR on port 1 (Format 1c),

Transmission possibilities in the third embodiment:

| | Port 0 | Port 1 | No. of States |
|---|---|---|---|
| (a) | 1 state (F1) × | 4 states (F1c) | 4 |
| (b) | 4 state (F1c) × | 1 state (no SR) | 4 |
| (c) | 1 state (no SR) × | 4 states (F1c) | 4 |

Total number of states = 12

In a similar way to the first and second embodiments, information on buffer status can be indicated by the ports on which transmission is carried out as well as using the QPSK symbol sent using Format 1c. A drawback of this embodiment is that if ACK/NACK is transmitted at the same time (e.g. using Format 1a/1b), the eNB may not be able to distinguish between the different cases. This difficulty may be resolved by reducing the amount of buffer status information sent when ACK/NACK is present. In this case, the following (single option for used ports) can be transmitted, for example (like in the second embodiment):

SR+ACK/NACK on port 0 (Format 1a/1b), SR on port 1 (Format 1c)

### Fourth Embodiment

The fourth embodiment is like the third embodiment except that Format 1c is transmitted on both ports. For the case of no ACK/NACK this gives:
SR on port 0 (Format 1c), SR on port 1 (Format 1c)
SR on port 0 (Format 1c), No SR on port 1
No SR on port 0, SR on port 1 (Format 1c),

In a similar way to the third embodiment, information on buffer status can be indicated by the ports on which transmission is carried out as well as using the QPSK symbols sent using Format 1c. Now up to 24 different combinations of bits and ports can be used to indicate on buffer status, as follows.

Transmission possibilities in the fourth embodiment:

| | Port 0 | Port 1 | No. of States |
|---|---|---|---|
| (a) | 4 states (F1c) × | 4 states (F1c) = | 16 |
| (b) | 4 states (F1c) × | 1 state (no SR) = | 4 |
| (c) | 1 state (no SR) × | 4 states (F1c) = | 4 |

Total number of states = 24

This has a similar drawback to the third embodiment in that if ACK/NACK is transmitted at the same time (e.g. using Format 1a/1b) only one instance of Format 1c can be used. Therefore the amount of buffer status information is reduced when ACK/NACK is present, for example using (like in the second embodiment):
SR+ACK/NACK on port 0 (Format 1a/1b), SR on port 1 (Format 1c)

In a variation of this embodiment, in the case of no ACK/NACK, only the following possibility is used:—
SR on port 0 (Format 1c), SR on port 1 (Format 1c)

This provides a smaller information content for buffer status indication, but does not require the eNB to distinguish the different cases of “No SR”. This variation still provides 16 states for signifying buffer status information to the network.

Various modifications are possible within the scope of the present invention.

The present invention has been described in terms of a UE communicating with a base station, but the invention may be applied to any station communicating wirelessly with the network, for example a relay node.

Although described with respect to two antenna ports at the UE, the present invention is applicable to a wireless station with any number of antenna ports. It is noted that the concept of “antenna port” in LTE is distinct from the number of physical antennas. This includes the case of one port with more than one distinct resource. The transmissions from different antenna ports are not necessarily simultaneous. The term “antenna port” is thus to be interpreted broadly.

The described embodiments are applied primarily to conveying additional information at the time of transmitting a scheduling request (SR), but this is not essential. The same principle may be applied to any signal capable of being sent simultaneously from multiple antenna ports using different resources.

In the above embodiments, information on amounts of data in the LCGs is conveyed. However, it is not essential to signify any absolute amount of data. Relative amounts of data among the LCGs and/or percentage fill levels of buffers are other possibilities.

The invention has been described with reference to LTE FDD, but can also be applied for LTE TDD, and the principle applied to other communications systems such as UMTS.

In the current embodiments it is assumed that the UL and DL carriers are paired. However, the invention could also be applied with an asymmetric number of UL and DL carriers (or asymmetric UL and DL bandwidths).

To summarise, embodiments of the present invention enable a mobile terminal to transmit buffer status information to a base station soon after data becomes available, but where no suitable resources for transmission of a buffer status report (BSR) have been granted by the network. In LTE, this situation leads to the triggering of a scheduling request (SR) at the mobile terminal. The invention provides for transmission of buffer status (or possibly other information) along with the SR for the case of terminals with more than one antenna port simultaneously available in the uplink (UL). The invention is based on the recognition that LTE Release 10 provides for SR to be transmitted simultaneously on different UL antenna ports with different resources. The additional information on buffer status may be encoded by transmission of different SR signals (e.g. QPSK symbols) on the different antenna ports.

### INDUSTRIAL APPLICABILITY

The invention allows an LTE network to receive up-to-date UE buffer status (e.g. similar to BSR) with minimal delay after a scheduling request is triggered (i.e. at the same time as SR is transmitted). This will reduce latency (i.e. time delay to reach the required transmission rate), since the network can receive information on the amount of data ready for transmission by the UE. This allows the granting of a suitable amount of resources for scheduling UL transmission at the first opportunity. Since priority information can also be included with the buffer status, it also allows timely and appropriate scheduling and sharing of resources between UEs according to the priority of the UL data.

1. A wireless communication method in which a station is capable of performing transmission via a plurality of antenna ports simultaneously on an uplink to a wireless communication network, a plurality of transmission possibilities for said transmission being defined by the available antenna ports and/or formats available for transmitting from an antenna port, the station signifying information to the network by selecting from the transmission possibilities.

2. The wireless communication method according to claim 1 wherein the station selects from the plurality of transmission possibilities by selecting one or more of the antenna ports to be used for the transmission and/or by selecting, among a set of predefined formats, a format to be used for transmitting from the or each selected antenna port respectively.

3. The wireless communication method according to claim 1 wherein the transmission is a request for resources, the transmission having a content for requesting the resources whilst signifying the information by the transmission possibility selected.

4. The wireless communication method according to claim 1 wherein a selected transmission possibility uses a plurality of the available antenna ports to which distinct uplink resources are assigned.

5. The wireless communication method according to any claim 1 wherein a selected transmission possibility uses a format having a predetermined modulation scheme for signals transmitted from a said antenna port.

6. The wireless communication method according to claim 5 wherein the network is based on LTE Release 10 or later and the transmission comprises a scheduling request.

7. The wireless communication method according to claim 6 wherein the predetermined modulation scheme for signals transmitted from a said antenna port is one defined in LTE for a scheduling request.

8. The wireless communication method according to claim 6 wherein the predetermined modulation scheme for signals transmitted from a said antenna port is distinct from any defined in LTE for a scheduling request.

9. The wireless communication method according to claim 1 wherein the network is based on LTE and the transmission comprises an ACK/NACK signal transmitted from one antenna port.

10. The wireless communication method according to claim 1 wherein the network is based on LTE and the information comprises information on buffer status.

11. The wireless communication method according to claim 10 wherein the information on buffer status comprises information on at least one logical channel group among a plurality of logical channel groups.

12. The wireless communication method according to claim 11 wherein the information on buffer status comprises any of:
an indication of an amount of data in a logical channel group having a highest priority among the plurality of logical channel groups;
an indication of a total amount of data in the plurality of logical channel groups;
an identification of a logical channel group having the greatest amount of data among the logical channel groups;
an identification of the logical channel group with the highest priority which has any data available for transmission; and
an identification of the logical channel group with the highest priority which has data of an amount exceeding a threshold available for transmission.

13. A wireless communication system comprising a subscriber station and a base station and in which the subscriber station comprises multiple antennas capable of performing transmission via a plurality of antenna ports simultaneously on an uplink to the base station, a plurality of transmission possibilities for said transmission being defined by the available antenna ports and/or formats available for transmitting from an antenna port, the subscriber station configured to signify information to the base station by selecting from the transmission possibilities.

14. A subscriber station which is a station for use in the method according to claim 1 and configured to perform selection among said transmission possibilities for signifying said information to the network.

15. Base station equipment for use in the wireless communication method according to claim 1 and configured to extract said information from said transmission by recognising which one or more of the antenna ports has been used for the transmission by the station and/or by recognising, among a set of predefined formats, which format has been used for transmitting from the or each selected antenna port respectively.

16. (canceled)

17. The subscriber station according to claim 14 including a non-transitory computer-readable medium storing computer-readable instructions which, when executed by a processor of a transceiver device in a wireless communication system, cause the device to provide the subscriber station.

18. The base station equipment according to claim 15 including a non-transitory computer-readable medium storing computer-readable instructions which, when executed by a processor of a transceiver device in a wireless communication system, cause the device to provide the base station equipment.
